(19) United States
(12) Patent Application Publication
(10) Pub. No.: US 2025/0102318 A1
(43) Pub. Date: Mar. 27, 2025

(54) SYSTEMS AND METHODS FOR ASSOCIATING VEHICLE TRACE DATA WITH ROAD GRAPHS

(71) Applicant: Toyota Jidosha Kabushiki Kaisha, Toyota-shi Aichi-ken (JP)

(72) Inventor: Alexander Christoph Schaefer, Fremont, CA (US)

(21) Appl. No.: 18/473,621

(22) Filed: Sep. 25, 2023

(51) Int. Cl. G01C 21/00

(52) U.S. Cl. CPC G01C 21/3837; G01C 21/3815; G01C 21/3867

(57) ABSTRACT

Systems, methods, and other embodiments described herein relate to associating vehicle sensor data with road graphs. In one embodiment, a system includes a processor and a memory storing machine-readable instructions. The machine-readable instructions, when executed by the processor, cause the processor to 1) map frames of a vehicle trace along a road to a respective nearest portion of a road graph for the road, 2) identify, as a non-baseline segment, a portion of the road graph for which there is a mapping inconsistency, and 3) for a baseline segment, associate vehicle sensor data captured at the frames with the respective nearest portion of the road graph.

### TECHNICAL FIELD

The subject matter described herein relates, in general, to vehicle trace data and, more particularly, to accurately mapping vehicle trace data to road graphs for a road.

### BACKGROUND

A road graph is a digital representation of a road as a sequence of edges and connecting nodes. Nodes that connect two edges indicate geometrical data for the road, while nodes that connect more than two edges indicate geometrical data and topological data for the road. In urban centers, road graph maps can be quite complex as numerous roads intersect, merge, and even cross over one another. Road graphs may serve as the basis for navigation systems that direct drivers through the complex network of roads to reach a desired destination. In another example, the road graph may serve as a reference by which an autonomous driving system of an autonomous vehicle controls the vehicle to a desired destination. While particular reference is made to particular uses of a road graph, road graphs are used for other purposes, such as digital representation of a road network.

As such, as the information/detail provided by the road graph increases, so does the capability of the navigation, autonomous driving, and other driver assistance systems that aid a driver in executing any number of actions within a vehicle and that rely on the road graph to provide the aforementioned driver assistance.

### SUMMARY

In one embodiment, example systems and methods relate to a manner of improving road graph representations of roads.

In one embodiment, a mapping system for improving road graph representations of a road network is disclosed. The mapping system includes one or more processors and a memory communicably coupled to the one or more processors. The memory stores instructions that, when executed by the one or more processors, cause the one or more processors to 1) map frames of a vehicle trace along a road to a respective nearest portion of a road graph for the road, 2) identify, as a non-baseline segment, a portion of the road graph for which there is a mapping inconsistency, and 3) for a baseline segment, associate vehicle sensor data captured at the frames with the respective nearest portion of the road graph.

In one embodiment, a non-transitory computer-readable medium for improving road graph representations of a road and including instructions that, when executed by one or more processors, cause the one or more processors to perform one or more functions is disclosed. The instructions include instructions to 1) map frames of a vehicle trace along a road to a respective nearest portion of a road graph for the road, 2) identify, as a non-baseline segment, a portion of the road graph for which there is a mapping inconsistency, and 3) for a baseline segment, associate vehicle sensor data captured at the frames with the respective nearest portion of the road graph.

In one embodiment, a method for improving road graph representations is disclosed. In one embodiment, the method includes 1) mapping frames of a vehicle trace along a road to a respective nearest portion of a road graph for the road, 2) identifying, as a non-baseline segment, a portion of the road graph for which there is a mapping inconsistency, and 3) for a baseline segment, associating vehicle sensor data captured at the frames with the respective nearest portion of the road graph.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle with which systems and methods disclosed herein may be implemented.

FIG. 2 illustrates one embodiment of a mapping system that is associated with enhancing road graph representations of a road network with vehicle sensor information.

FIG. 3 illustrates one embodiment of the mapping system of FIG. 2 in a cloud-computing environment.

FIG. 4 illustrates a flowchart for one embodiment of a method that is associated with enhancing road graph representations of a road with vehicle sensor data.

FIGS. 5A-5E illustrate the mapping of a road graph to vehicle trace data.

### DETAILED DESCRIPTION

Systems, methods, and other embodiments associated with improving road graph representations of a road are disclosed herein. As previously described, a roadway may be represented as a road graph where edges representative of road portions are connected via nodes. The nodes of the graph encode geometrical and, in some cases, topological data of the road. Road graphs are used in a variety of circumstances. For example, mapping modules use road graphs to provide navigation instructions to a driver. In another example, autonomous driving modules use road graphs to drive a vehicle autonomously through a road network to a destination. However, road graphs may be limited in the information they convey to drivers or systems. As a particular example, a road graph may not indicate an elevation of the road. As such, a road graph that does not indicate road elevation may incorrectly represent a cloverleaf interchange where a road crosses over itself. In this example, the road graph may not indicate which road of the cloverleaf exchange passes over the other. For example, the road graph may not convey whether an east/west road segment passes over or under a north/south segment. Moreover, without elevation data, a two-dimensional representation of the road network may not be able to be presented three-dimensionally. As another example, a road graph may not indicate the directionality of a road. For example, a road graph may not indicate a one-way road as such. Accordingly, a navigation system that relies on this road graph may direct a driver to enter a one-ray road traveling in the wrong direction, thus putting the driver and other motorists in a dangerous situation.

Vehicle sensor data could be used to augment the road graph. For example, a vehicle may be equipped with a global positioning system (GPS), which records the elevation of the vehicle over time. Turning to the cloverleaf interchange example provided above, the road graph could be augmented by the vehicle elevation data such that the road could be represented to indicate which portion of the cloverleaf exchange passes over another portion of the cloverleaf exchange. Vehicle trace data can be used to associate vehicle sensor data with particular locations on the road graph. Vehicle trace data refers to the record of a vehicle's location over time. In this example, vehicle trace information is mapped to the road graph such that vehicle sensor data is associated with particular locations of the road graph. That is, vehicle sensor data is mapped to frames of the vehicle trace. As the vehicle trace frames are mapped to particular locations on the road graph, the vehicle sensor data may then be associated with the pertinent locations on the road graph.

However, given a complex network of roads, it may be difficult to associate the vehicle sensor information with the appropriate edges and nodes of a road graph. For example, a vehicle may be traveling on a road segment that passes over another road segment. In this example, each road is represented by the road graph. Given the crossing nature of these roads, a system may incorrectly map the vehicle trace to the nodes of the underpass road.

Accordingly, the present specification describes a system that decreases the ambiguity of a mapping between a vehicle trace and a road graph such that vehicle sensor data (e.g., elevation, directionality, or other vehicle sensor output) can be mapped to the correct road graph edge/node, thus providing greater utility of a road graph in any number of vehicle systems.

Specifically, the system associates the vehicle trace frames with the edges and nodes of a road graph. Given the associations, the system identifies those portions of the road graph with no mapping inconsistencies. A portion of the road graph with no mapping inconsistencies is referred to as a baseline segment. Non-baseline segments, those segments with a mapping inconsistency, and the corresponding trace data, are cut from the road graph. Vehicle sensor data at the frames is associated with the respective nearest portion of the road graph for a reference baseline segment, which may be the longest baseline segment. This process iterates for each non-baseline segment, with inconsistent segments and associated trace data being cut and vehicle sensor data being associated with consistent segments. This ultimately resolves any mapping inconsistencies in the road graph such that vehicle sensor data can be mapped to the road graph. In this way, the disclosed systems, methods, and other embodiments improve the road graph representation of the road by unambiguously incorporating vehicle sensor data into the road graph.

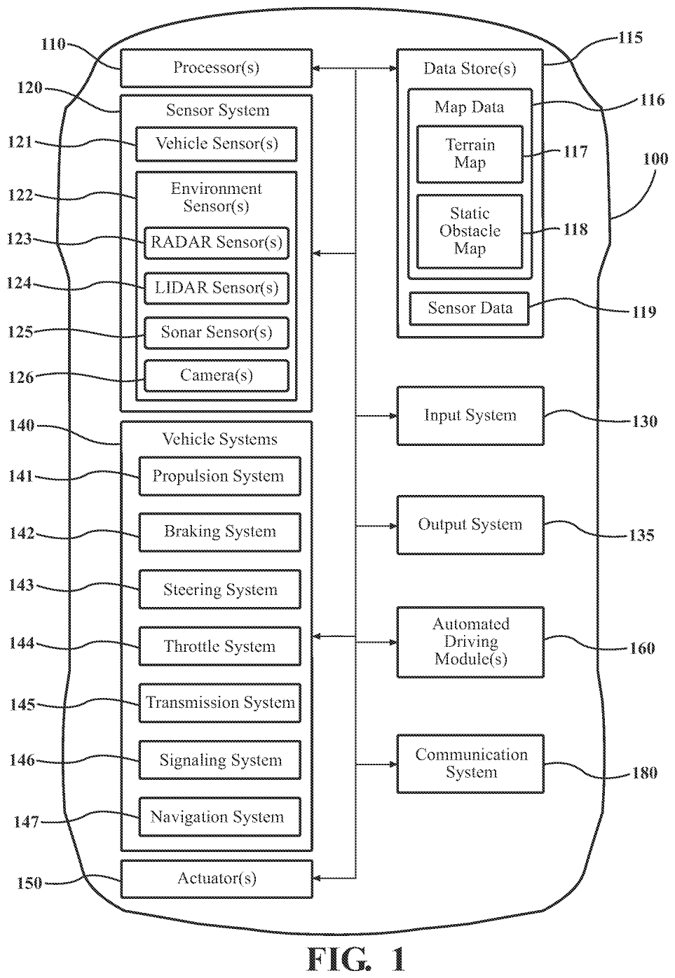

Referring to FIG. 1, an example of a vehicle 100 is illustrated. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with associating vehicle trace data with road graphs.

The vehicle 100 also includes various elements. It will be understood that in various embodiments it may not be necessary for the vehicle 100 to have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

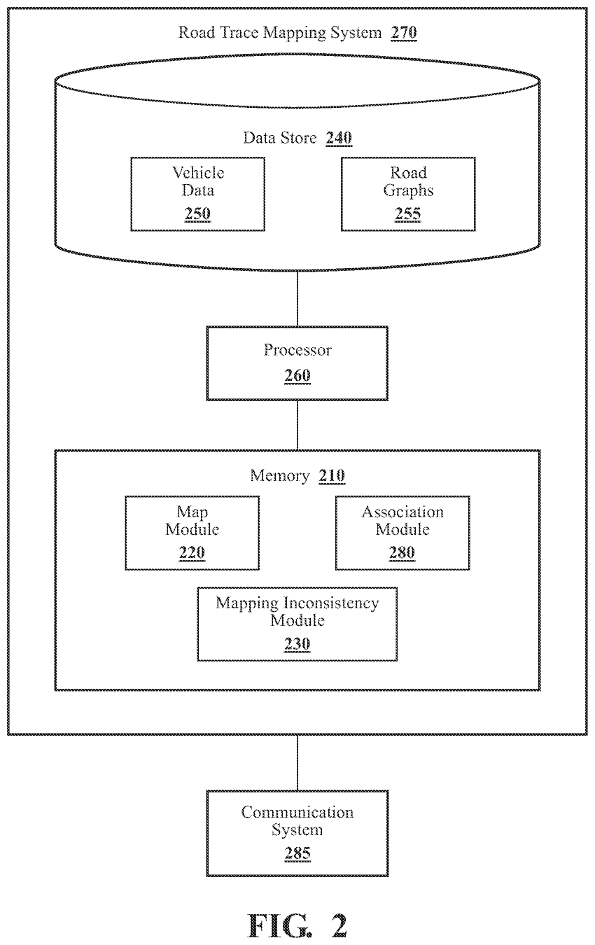

Some of the possible elements of the vehicle 100 are shown in FIG. 1 and will be described along with subsequent figures. However, a description of many of the elements in FIG. 1 will be provided after the discussion of FIGS. 2-5E for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

The vehicle 100 and the mapping system function in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a communication protocol, such as a WiFi, DSRC, V2I, V2V, or another suitable protocol for communicating between the vehicle 100 and other entities in the cloud environment. Moreover, the communication system 180, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the mapping system 270 can leverage various wireless communication technologies to provide communications to other entities, such as members of the cloud-computing environment.

With reference to FIG. 2, one embodiment of the mapping system 270 is illustrated. The mapping system 270 is shown as including a processor 260. Accordingly, the processor 260 may be a part of the mapping system 270, the mapping system 270 may include a separate processor 260, or the mapping system 270 may access the processor 260 through a data bus or another communication path. In one embodiment, the mapping system 270 includes a memory 210 that stores a map module 220, a mapping inconsistency module 230, and an association module 280. The memory 210 is a random-access memory (RAM), read-only memory (ROM), a hard-disk drive, a flash memory, or another suitable memory for storing the modules 220, 230, and 280. The modules 220, 230, and 280 are, for example, computer-readable instructions that when executed by the processor 260 cause the processor 260 to perform the various functions disclosed herein. In alternative arrangements, the modules 220, 230, and 280 are independent elements from the memory 210 that are, for example, comprised of hardware elements. Thus, the modules 220, 230, and 280 are alternatively ASICs, hardware-based controllers, a composition of logic gates, or another hardware-based solution.

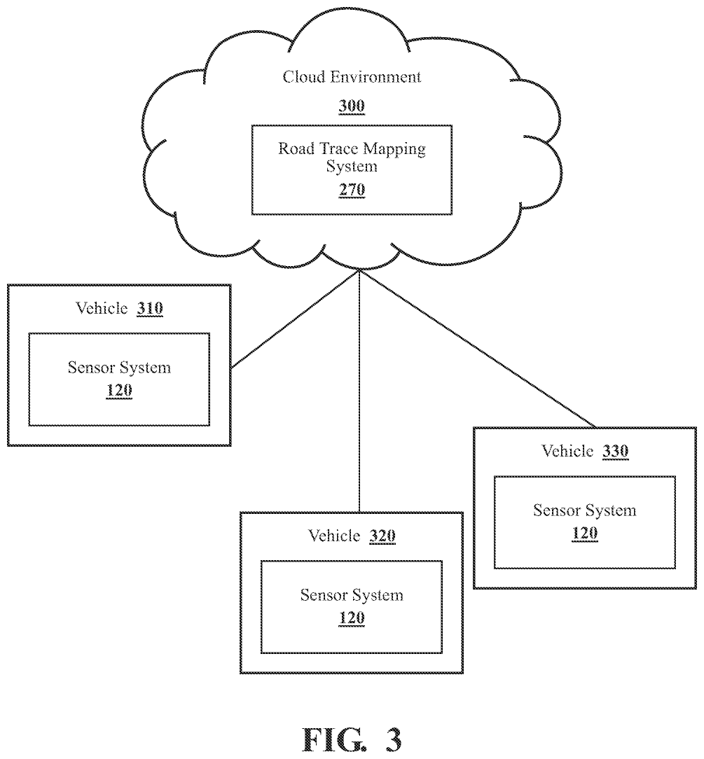

The mapping system 270 as illustrated in FIG. 2 is generally an abstracted form of the mapping system 270. FIG. 3 illustrates one example of a cloud-computing environment 300 that may be implemented along with the mapping system 270. As illustrated in FIG. 3, the mapping system 270 is embodied at least in part within the cloud-computing environment 300.

In one or more approaches, the cloud environment 300 may facilitate communications between multiple different vehicles to acquire and distribute information between vehicles 310, 320, and 330.

Accordingly, as shown, the mapping system 270 may include separate instances within one or more entities of the cloud-based environment 300, such as servers, and also instances within vehicles that function cooperatively to acquire, analyze, and distribute the noted information. In a further aspect, the entities that implement the mapping system 270 within the cloud-based environment 300 may vary beyond transportation-related devices and encompass mobile devices (e.g., smartphones), and other devices that may be carried by an individual within a vehicle, and thereby can function in cooperation with the vehicle 100. Thus, the set of entities that function in coordination with the cloud environment 300 may be varied.

The cloud-based environment 300 itself, as previously noted, is a dynamic environment that comprises cloud members that are routinely migrating into and out of a geographic area. In general, the geographic area, as discussed herein, is associated with a broad area, such as a city and surrounding suburbs. In any case, the area associated with the cloud environment 300 can vary according to a particular implementation but generally extends across a wide geographic area.

Moreover, in one embodiment, the mapping system 270 includes the data store 240. The data store 240 is, in one embodiment, an electronic data structure stored in the memory 210 or another data storage device and that is configured with routines that can be executed by the processor 260 for analyzing stored data, providing stored data, organizing stored data, and so on. Thus, in one embodiment, the data store 240 stores data used by the modules 220, 230, and 280 in executing various functions. In one embodiment, the data store 240 stores vehicle data 250, which includes vehicle trace data and sensor data collected by a vehicle.

As described above, vehicle trace data refers to a time-based record of vehicle location. The location may be coordinate-based. That is, at predetermined intervals, a location recording sensor device of the vehicle 100, such as a GPS, records the location of the vehicle, for example, as coordinates. As such, the vehicle trace data comprises a geographic log of the vehicle's 100 movements across a road network. While particular reference is made to coordinate-based vehicle location measurements, the vehicle trace data may record the vehicle location using any number of mechanisms. Note that each instance of information recordation is referred to as a frame. In an example, the frames may be sequentially indexed over time. For example, vehicle location data may be collected at sequential times T₀, T₁, T₂ . . . Tₙ.

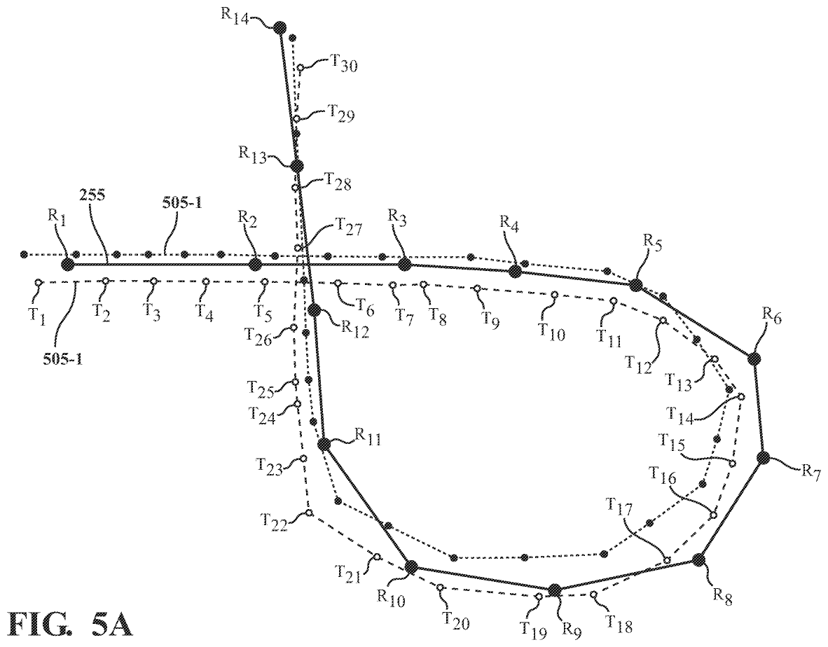

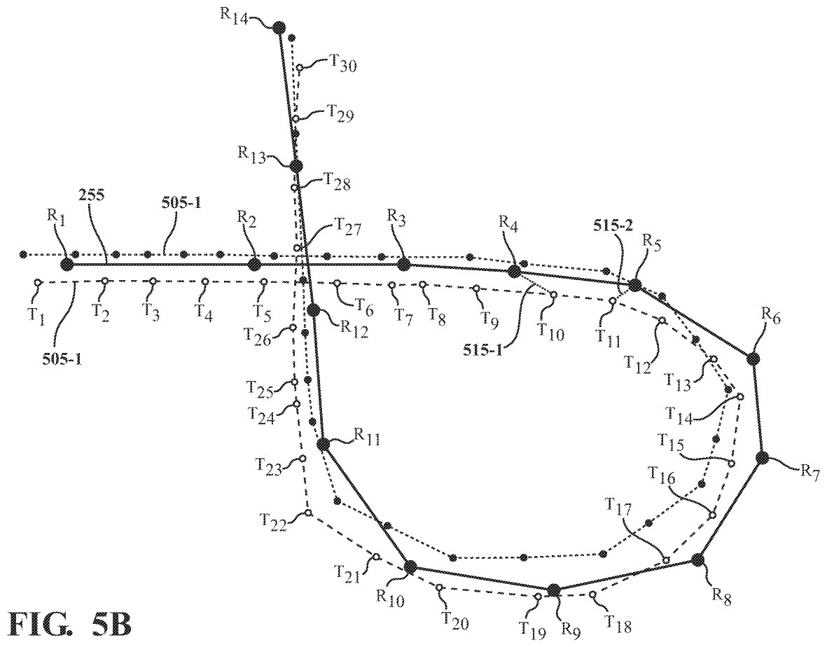

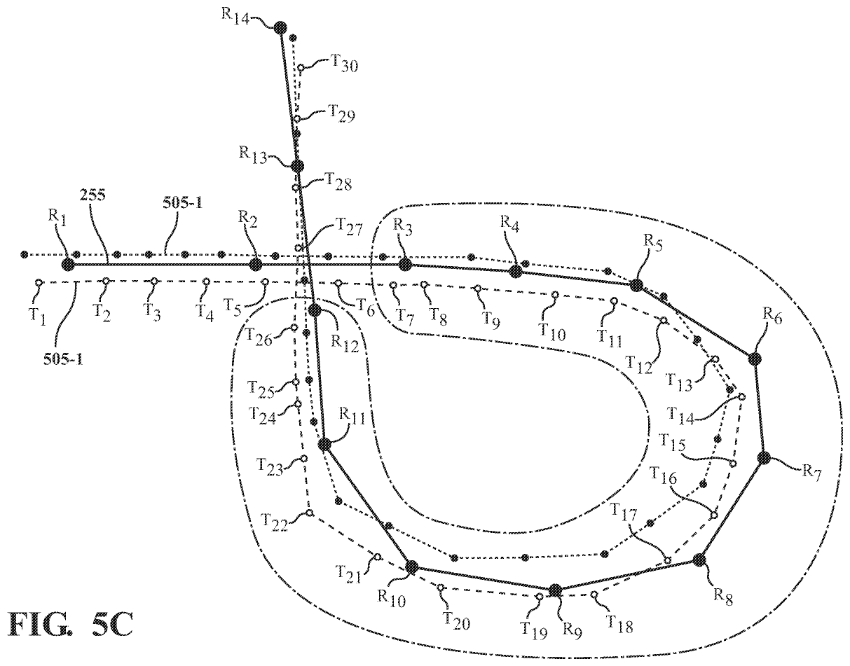

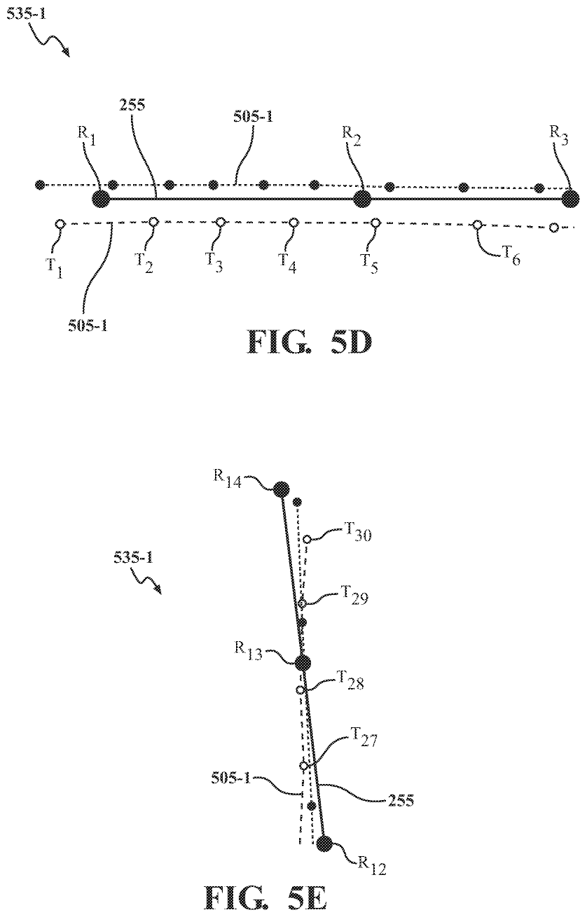

The vehicle data 250 includes this vehicle trace data for any number of vehicles to which the mapping system 270 is connected. That is, as depicted in FIG. 3, the mapping system 270 is connected to any number of vehicles 310, 320, and 330 via the communication system 285 of the mapping system 270 and the communication systems 180 of the respective vehicles 310, 320, and 330. As such, the location recording sensors of the vehicles 100 periodically transmit the location of the respective vehicle to the mapping system 270, such that the data store 240 includes vehicle trace data for hundreds, thousands, or more vehicles that travel a road network. As described above, this vehicle trace data is associated with road graphs such that vehicle sensor data may be appropriately and correctly mapped to the corresponding edges of the road graph. FIGS. 5A-5E represent vehicle traces as dashed lines.

The vehicle data 250 also includes sensor data collected by the vehicle sensor system(s) 120. The sensor data may include observations of a surrounding environment of the vehicle 100 and/or information about the vehicle 100 itself. The sensor system 120 can include one or more sensors. Various examples of different types of sensors will be described herein. However, it will be understood that the embodiments are not limited to the particular sensors described. In various configurations, the sensor system 120 includes one or more vehicle sensors 121 and/or one or more environment sensors 122. The vehicle sensor(s) 121 function to sense information about the vehicle 100 itself. In one or more arrangements, the vehicle sensor(s) 121 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100. In one or more arrangements, the environment sensors 122 sense a surrounding environment (e.g., external) of the vehicle 100 and/or, in at least one arrangement, an environment of a passenger cabin of the vehicle 100. For example, the one or more environment sensors 122 sense objects the surrounding environment of the vehicle 100. Such obstacles may be stationary objects and/or dynamic objects. Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 includes one or more radar sensors 123, one or more LIDAR sensors 124, one or more sonar sensors 125 (e.g., ultrasonic sensors), and/or one or more cameras 126 (e.g., monocular, stereoscopic, RGB, infrared, etc.).

The vehicle data 250 includes this sensor data for any number of vehicles connected to the mapping system 270. That is, as depicted in FIG. 3, the mapping system 270 is connected to any number of vehicles 310, 320, and 330, via the communication system 285 of the mapping system and the communication systems 180 of the respective vehicles 310, 320, and 330. As such, the sensor system 120 of the vehicles 310, 320, and 330 transmit the output of the respective sensors to the mapping system 270, such that the data store 240 includes sensor data for hundreds, thousands, or more vehicles that travel a road network. As described above, this sensor data is associated with the road graph such that the road graph may be enhanced to reflect additional information about the road network.

The data store 240 also includes the road graphs 255. As described above, a road graph 255 represents a road and is made up of edges representing road sections joined by nodes. Nodes that connect two edges include geometrical data, while nodes that connect more than two edges also indicate topological data. The data store 240 includes road graphs 255 for any number of roads in a given area. In an example, the road graph 255 may be for a particular area of a road network, for example, a road network associated with a district, city, state, or other geographic region.

FIGS. 5A-5E represent the road graph 255 as a solid line. As described above, the road graph 255 is used by any number of vehicle systems including, but not limited to, a navigation system 147 and an automated driving module 160. However, the road graph 255 may be ill-equipped to support these systems due to a lack of information contained therein. For example, the road graph 255 may not indicate environmental conditions, such as heavy traffic, road elevation, directionality, infrastructure features, etc. As such, the mapping system 270 augments or enhances the road graph 255 by incorporating into the road graph 255 or associating with the road graph 255, vehicle sensor information that provides additional contextual information as described below.

The map module 220, in one embodiment, includes instructions that cause the processor 260 to map frames of a vehicle trace along a road to a respective nearest portion of a road graph 255 for the road. As such, the map module 220 generally includes instructions that function to control the processor 260 to receive data inputs from one or more sensors of the vehicle 100. As provided for herein, the map module 220, in one embodiment, acquires the vehicle trace data that includes at least location information for the vehicles over time.

Accordingly, the map module 220, in one embodiment, controls the respective sensors to provide the data inputs in the form of the vehicle trace data. Additionally, while the map module 220 is discussed as controlling the various sensors to provide the vehicle trace data, in one or more embodiments, the map module 220 can employ other techniques to acquire the vehicle trace data that are either active or passive. For example, the map module 220 may passively sniff the vehicle trace data from a stream of electronic information provided by the various sensors to further components within the vehicle 100.

In addition to collecting vehicle trace data, the map module 220 maps frames of a vehicle trace along a road to a respective nearest portion of a road graph 255 for the road. That is, before vehicle sensor data can be associated with the road graph, a relationship between 1) the vehicle trace frame associated with the vehicle sensor data and 2) the road graph 255 is established. That is, the map module 220 identifies a point on the road graph 255 with which the vehicle sensor data should be associated. In general, this includes identifying the nearest point on the road graph 255 for each frame of the vehicle trace. In an example, the nearest point on the road graph 255 may be the point with the shortest Euclidean distance to the vehicle trace frame.

This association may occur in a variety of ways. In one example, the road graph 255 is continuously indexed or linearly referenced. For example, the map module 220 maps frames of the vehicle trace to a respective nearest portion of a road graph 255, regardless of whether the nearest portion is a node. In this example, the nearest portion of the road graph 255 may be that portion of the road graph that is orthogonal to the vehicle trace frame. In another example, the road graph 255 is discretely indexed, in which case the map module 220 maps frames of the vehicle trace to a respective nearest portion of the road graph 255 by mapping the frames to a respective nearest node of the road graph 255. FIG. 5B below depicts the vehicle frame traces being mapped to the nearest node of the road graph 255.

Note that the operations of the map module 220, the mapping inconsistency module 230, and the association module 280 are recursive. That is, following the initial mapping of vehicle traces to the road graph 255, the mapping inconsistency module 230 identifies 1) baseline segments for which vehicle sensor data is to be associated with the road graph 255 and 2) non-baseline segments for which vehicle sensor data is not to be associated to the road graph 255. The association module 280 then associates vehicle sensor data to at least one baseline segment of the road graph 255, which at least one baseline segment may be the longest baseline segment.

Following this association, the map module 220 operates to, for each non-baseline segment, map frames of the vehicle trace along the non-baseline segment to a respective nearest portion of the road graph 255. However, certain rules are enforced during the second and subsequent road graph/trace mapping iterations to address any mapping inconsistencies. Specifically, non-baseline segments of the road graph 255 are associated with frames of the vehicle trace based on a timestamp of the frames and a timestamp of the frames associated with the baseline segment. In an example, the map module 220 1) associates a non-baseline segment that is geographically before the baseline segment with frames of the vehicle trace that are temporally before the frames associated with the baseline segment and 2) associates a non-baseline segment that is geographically after the baseline segment with frames of the vehicle trace that are temporally after the frames associated with the baseline segment.

For example, as depicted in FIG. 5C, a baseline segment may start at a road node having an index, R₃. This road node may be associated with a frame having a time stamp, T₇. As such, any frame having a time stamp before T₇ is associated with a portion of the road graph 255 that is geographically before (i.e., has an index less than) or up to R₃. Similarly, as depicted in FIG. 5C, the baseline segment may end at a road node having an index R₁₂. This road node may be associated with a frame having a time stamp, T₂₆. As such, any frame having a time stamp after T₂₆ is associated with a portion of the road graph 255 that is geographically after (e.g., has an index greater than) or equal to R₁₂. This addresses a mapping inconsistency that may result from a non-sequential trace/node mapping, as described below. Note that in the example described above, nodes are indexed sequentially. However, nodes may be organized in different fashions. Regardless, as described above, the map module 220 1) associates a non-baseline segment that is geographically before the baseline segment with frames of the vehicle trace that are temporally before the frames associated with the baseline segment and 2) associates a non-baseline segment that is geographically after the baseline segment with frames of the vehicle trace that are temporally after the frames associated with the baseline segment.

In one approach, the map module 220 implements and/or otherwise uses a machine learning algorithm. In one configuration, the machine learning algorithm is embedded within the map module 220, such as a convolutional neural network (CNN), to perform vehicle trace/road graph associations over the vehicle trace data and road graph 255, from which further information is derived. Of course, in further aspects, the map module 220 may employ different machine learning algorithms or implement different approaches for performing the mapping which can include deep convolutional encoder-decoder architectures, dilated convolutions, or another suitable approach that generates mappings as described above. Whichever particular approach the map module 220 implements, the map module 220 provides an output associating the road graph with vehicle trace data.

The mapping system 270 also includes a mapping inconsistency module 230, which, in one embodiment, includes instructions that cause the processor 260 to identify, as a non-baseline segment, a portion of the road graph 255 for which there is a mapping inconsistency. That is, the mapping inconsistency module 230 differentiates baseline segments with no mapping inconsistencies from non-baseline segments with mapping inconsistencies. As such, the mapping inconsistency module 230 generally includes instructions that function to control the processor 260 to receive data inputs from one or more sensors of the vehicle 100. As provided for herein, the mapping inconsistency module 230, in one embodiment, acquires the vehicle trace data and the road graph 255.

Accordingly, the mapping inconsistency module 230, in one embodiment, controls the respective sensors to provide the data inputs in the form of the vehicle trace data. Additionally, while the mapping inconsistency module 230 is discussed as controlling the various sensors to provide the vehicle trace data, in one or more embodiments, the mapping inconsistency module 230 can employ other techniques to acquire the vehicle trace data that are either active or passive. For example, the mapping inconsistency module 230 may passively sniff the vehicle trace data from a stream of electronic information provided by the various sensors to further components within the vehicle 100.

In addition to collecting vehicle trace data, the mapping inconsistency module 230 identifies as a non-baseline segment, a portion of the road graph 255 for which there is a mapping inconsistency. That is, before vehicle sensor data can be associated with the road graph 255, any ambiguity in the mapping is to be resolved as an ambiguity may result in vehicle sensor data being incorrectly associated with a road graph node. Such incorrect labeling may create an anomaly in the road graph 255, which may affect the operation of the system that relies on the road graph 255. For example, it may be that a vehicle has traversed across an overpass road and collected elevation data at particular intervals (i.e., frames). A system may incorrectly assign this elevation data to an underpass road due to a mapping inconsistency at the crossing of the overpass road over the underpass road. The mapping inconsistency module 230 identifies such an inconsistency in the mapping generated by the map module 220 to avoid incorrect associations.

In one example, the mapping inconsistency module 230 identifies a mapping inconsistency based on a connection of nodes of the road graph. That is, the road graph may include information regarding the connectivity of various nodes. Accordingly, if the mapping module 220 maps time-sequential frames to non-connected nodes, the mapping inconsistency module 230 may identify this as a mapping inconsistency.

In one example, the mapping inconsistency module 230 identifies an inconsistency as an out-of-sequence mapping between a frame and the respective nearest portion of the road graph. That is, one would expect a monotonical relationship between vehicle trace frame indices and road graph node indices. Any variation from this may be identified as a mapping inconsistency. In contrast, those segments for which no such variation exists are defined as baseline segments for which there is no data ambiguity.

For example, Table (1) below depicts a mapping relationship between vehicle trace frames and the nearest node of the road graph 255 depicted in FIG. 5C.

TABLE 1

| Vehicle Trace | Road Graph Node |
|---|---|
| Frame Index (Tₙ) | (Rₙ) |
| T₁ | R₁ |
| T₂ | R₁ |
| T₃ | R₁ |
| T₄ | R₂ |
| T₅ | R₂ |
| T₆ | R₁₂ |
| T₇ | R₃ |
| T₈ | R₃ |
| T₉ | R₄ |
| T₁₀ | R₄ |
| T₁₁ | R₅ |
| T₁₂ | R₅ |
| T₁₃ | R₆ |
| T₁₄ | R₆ |
| T₁₅ | R₇ |
| T₁₆ | R₈ |
| T₁₇ | R₈ |
| T₁₈ | R₉ |
| T₁₉ | R₉ |
| T₂₀ | R₁₀ |
| T₂₁ | R₁₀ |
| T₂₂ | R₁₁ |
| T₂₃ | R₁₁ |
| T₂₄ | R₁₁ |
| T₂₅ | R₁₁ |
| T₂₆ | R₁₂ |
| T₂₇ | R₂ |
| T₂₈ | R₁₃ |
| T₂₉ | R₁₃ |
| T₃₀ | R₁₄ |

Table (1) shows that an out-of-sequence mapping exists at T₆ and T₂₇. This inconsistency may result in vehicle sensor data collected at T₆ being associated with the nearest point on the road graph, R₁₂, when the vehicle was actually on a road section associated with R₂. To avoid this error, the mapping inconsistency module identifies the section R₃-R₁₂ as a baseline segment (for which vehicle sensor data will be associated with the road graph 255) due to the lack of an out-of-sequence mapping in this segment and identifies sections R₁-R₂ and R₁₃-R₁₄ as non-baseline segments due to the identified out-of-sequence mapping between the frames and the respective nearest portion of the road graph 255.

Table (1) may also represent an example where the connectivity of nodes of the road graph leads to an identified mapping inconsistency. For example, the road graph may include information indicating R12 is not connected to either R2 or R3; that is, no road graph edge connects node R₁₂ to either R₂ or R₃. As such, the mapping inconsistency module 230 may query the road graph for this node connectivity information to identify a mapping inconsistency based on time-sequential frames (i.e., T₅, T₆, and T₇) being mapped to non-contacting nodes (R₂, R₁₂, and R₃).

In an alternate example where R₁₂ is connected to R₂ and R₃, for example at a road intersection, the mapping inconsistency module 230 may identify this portion of the road graph 255 as a baseline segment, notwithstanding the lack of monotonicity in the node indices. As such, the mapping inconsistency module 230 would determine whether two road graph nodes are connected, regardless of the monotonicity of the indices. This allows the mapping system 270 to process complex road graphs with intersections.

Other examples of mapping inconsistencies exist. For example, the mapping inconsistency module 230 may identify as a non-baseline segment, a portion of the road graph 255 that includes a frame that maps to multiple road graphs 255. For example, nodes of road graph 255 may be associated with a particular vehicle trace frame if the node is within a threshold distance of that frame. In this example, multiple road graphs 255 (e.g., an underpass and overpass road graph) may be within the threshold distance of that frame, even though the vehicle is traveling on just one of the roads. In this example, this section of the mapping may be identified as a mapping inconsistency.

While particular reference is made to particular mapping inconsistencies, other thresholds may be used to identify mapping inconsistencies. For example, the mapping inconsistency module 230 may identify a mapping inconsistency based on the distance between a frame and a respective nearest portion of the road graph 255 for a frame. In this example, a mapping inconsistency may be identified at a node where the distance between the node and a frame exceeds a threshold. As such, a baseline segment is a portion of the road graph 255 for which the average distance between frames and respective portions of the road graph 255 is the least or is less than a threshold amount. In another example, the mapping inconsistency module 230 may identify a mapping inconsistency based on the speed of the vehicle. For example, a mapping inconsistency may occur when a vehicle speed variation over several frames exceeds a threshold. As such, a baseline segment is a portion of the road graph 255 for which the average speed of vehicles has the least variation or has a variation less than a threshold amount.

Note again that the operations of the map module 220, the mapping inconsistency module 230, and the association module 280 are recursive. That is, as described above, following 1) the initial mapping of vehicle traces to the road graph 255, 2) the identification of baseline and non-baseline segments, and 3) the association of vehicle sensor data to at least one baseline segment, which may be a longest baseline segment, of the road graph 255, the map module 220 operates to, for each non-baseline segment, map frames of the vehicle trace along the non-baseline segment to a respective nearest portion of the non-baseline segment. As described above in this second iteration, any vehicle trace having a time stamp before T₇ is associated with a road graph node that is geographically before (i.e., has an index less than) or up to R₃. Similarly, any vehicle trace having a time stamp after T₂₆ is associated with a road graph node that is geographically after (i.e., has an index greater than) or equal to R12. This prevents the vehicle sensor data taken at T₆ from being associated with R12. Instead, the vehicle sensor data taken at T₆ is associated with R₂. Tables (2) and (3) presented below indicate the mapping of the first non-baseline segment (T₁-T₆) and the second non-baseline segment (T₂₇-T₃₀).

TABLE 2

| Vehicle Trace | Road Graph Node |
|---|---|
| Frame Index (Tₙ) | (Rₙ) |
| T₁ | R₁ |
| T₂ | R₁ |
| T₃ | R₁ |
| T₄ | R₂ |
| T₅ | R₂ |
| T₆ | R₃ |

TABLE 3

| Vehicle Trace | Road Graph Node |
|---|---|
| Frame Index (Tₙ) | (Rₙ) |
| T₂₇ | R₁₂ |
| T₂₈ | R₁₃ |
| T₂₉ | R₁₃ |
| T₃₀ | R₁₄ |

Following this mapping of the vehicle trace to non-baseline segments of the road graph, the mapping inconsistency module 230 identifies an inconsistent portion of the non-baseline segment as described above. As demonstrated in Tables (2) and (3), the mapping inconsistency has been addressed such that all vehicle sensor data may be mapped appropriately to the road graph 255.

In one approach, the mapping inconsistency module 230 implements and/or otherwise uses a machine learning algorithm. In one configuration, the machine learning algorithm is embedded within the mapping inconsistency module 230, such as a convolutional neural network (CNN), to perform mapping inconsistency identification over the vehicle trace data and road graph 255 from which further information is derived. Of course, in further aspects, the mapping inconsistency module 230 may employ different machine learning algorithms or implement different approaches for performing the mapping which can include deep convolutional encoder-decoder architectures, dilated convolutions, or another suitable approach that generates mappings as described above. Whichever particular approach the mapping inconsistency module 230 implements, the mapping inconsistency module 230 provides an output identifying inconsistent and consistent segments of the road graph mapping.

The mapping system 270 also includes an association module 280, which, in one embodiment, includes instructions that cause the processor 260 to associate, for the baseline segment, vehicle sensor data captured at the frames with the respective nearest portion of the road graph 255. That is, as described above, the road graph 255 includes data relied on by other systems to provide driver assistance, whether that driver assistance is navigational instructions, autonomous vehicle control, three-dimensional road network representation, or other type of assistance. As such, enhancements of the information associated with the road graph increase the ability of these different systems to aid the driver more effectively.

As such, the association module 280 generally includes instructions that function to control the processor 260 to receive data inputs from one or more sensors of the vehicle 100. The inputs are, in one embodiment, observations of one or more objects in an environment proximate to the vehicle 100 and/or other aspects about the surroundings. As provided for herein, the association module 280, in one embodiment, acquires sensor data such as vehicle dynamics data, elevation data, vehicle state data, or any other output of any sensor of the sensor system 120 of the vehicle 100. In further arrangements, the association module 280 acquires the sensor data from further sensors such as a radar sensor 123, a LiDAR sensor 124, and other sensors.

Accordingly, the association module 280, in one embodiment, controls the respective sensors to provide the data inputs in the form of the sensor data. Additionally, while the association module 280 is discussed as controlling the various sensors to provide the sensor data, in one or more embodiments, the association module 280 can employ other techniques to acquire the sensor data that are either active or passive. For example, the association module 280 may passively sniff the sensor data from a stream of electronic information provided by the various sensors to further components within the vehicle 100. Moreover, the association module 280 can undertake various approaches to fuse data from multiple sensors when providing the sensor data and/or from sensor data acquired over a wireless communication link (e.g., v2v) from one or more of the surrounding vehicles. Thus, the sensor data, in one embodiment, represents a combination of perceptions acquired from multiple sensors.

The sensor data may include, for example, information about the state of the vehicle and/or different components of the vehicle such as the components of the various vehicle systems 140, input system 130, output system 135, sensor system 120, and so on. Moreover, the association module 280, in one embodiment, controls the sensors to acquire the sensor data about an area that encompasses 360 degrees about the vehicle 100 in order to provide a comprehensive assessment of the surrounding environment.

In addition to collecting sensor data, the association module 280 associates, for a baseline segment, which may be a longest baseline segment, vehicle sensor data captured at the frames with the respective nearest portion of the road graph 255. Continuing the example above, Table (1) represents that the road segment T₇-T₂₆ as a baseline segment due to there being no mapping inconsistencies in this segment. Accordingly, vehicle sensor data collected at times T₇-T₂₆ is associated with the respective nearest portion of the road graph 255. In the example represented by Table (1), this may mean associating the vehicle sensor data with the associated nodes. In the example where the vehicle trace frames are mapped to the nearest portion of a line segment, the association module 280 may associate the vehicle sensor data to non-node portions of the road graph 255.

As described above, the vehicle 100 includes any number of sensors in a sensor system 120. The association module 280 associates the output of any number of these sensors with the associated portion of the road graph. In one particular example, the association module 280 associates elevation data from the vehicle to the respective nearest portion of the road graph 255. For example, the road graph 255 may be a two-dimensional representation of the road network without incorporating any vertical position characteristic of the road. In this example, a vehicle system or some other system may desire to generate a three-dimensional representation of the roadway. As such, the collected elevation data may be used to enhance the road graph 255 elevation characteristics of the road such that a downstream system may generate the 3D representation of the roadway.

In another example, the association module 280 associates directionality data for the vehicle with the respective nearest portion of the road graph 255. That is, the directionality of vehicle travel may be determined based on timestamps associated with each frame. In this example, the timestamp information may be used to indicate a directionality for a road where the sequential frame timestamps define the direction of the road.

While particular reference is made to elevation and directionality data being associated with the road graph 255, other vehicle sensor data may be passed to the road graph 255. As another example, the vehicle's external lights' state may be associated with the road graph 255. Such data may be used to determine whether an associated portion of a road is a tunnel. Another example may be the presence and quantity of detected pedestrians. Such data may be used to determine whether a particular road section has high pedestrian density such that a driver/autonomous system may alter the vehicle speed to ensure a safe pedestrian/motorist environment. While particular reference is made to a few examples of vehicle sensor data/road graph associations, the present mapping system 270 facilitates associating any variety of sensor data to the road graph 255 based on vehicle trace/road graph mapping.

Note again that the operations of the map module 220, the mapping inconsistency module 230, and the association module 280 are recursive. That is, as described above, following 1) the initial mapping of vehicle traces to the road graph 255, 2) the identification of baseline and non-baseline segments, and 3) the association of vehicle sensor data to a longest baseline segment of the road graph 255, the map module 220 operates to, for each non-baseline segment, map frames of the vehicle trace along the non-baseline segment to a respective nearest portion of the road graph 255 and the mapping inconsistency module 230 identifies an inconsistent portion of the non-baseline segment as described above. Furthermore, the association module 280, for a longest consistent portion of the non-baseline segment, associates vehicle sensor data captured at the frames with the respective nearest portion of the non-baseline segment. This process is repeated until all segments of the road graph 255 have been processed. By identifying mapping inconsistencies and then imposing certain mapping restrictions upon subsequent mappings, the recursive operations of the map module 220, the mapping inconsistency module 230, and the association module 280 map the vehicle traces/sensor data to the road graph to avoid mapping inconsistencies. FIGS. 5A-5E below further detail this recursive operation and highlight how mapping system 270 addresses an identified mapping inconsistency.

In one approach, the association module 280 implements and/or otherwise uses a machine learning algorithm. In one configuration, the machine learning algorithm is embedded within the association module 280, such as a convolutional neural network (CNN), to perform sensor data association over the sensor data and road graph 255 from which further information is derived. Of course, in further aspects, the association module 280 may employ different machine learning algorithms or implement different approaches for performing the sensor data association which can include deep convolutional encoder-decoder architectures, dilated convolutions, or another suitable approach that associates vehicle sensor data to the road graph 255 as described above. Whichever particular approach the association module 280 implements, the association module 280 provides an output associating vehicle sensor data with the road graph segments.

In one or more configurations, the mapping system 270 implements one or more machine learning algorithms. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the mapping system 270 or another system generally trains the machine learning algorithm according to a particular training approach, which may include supervised training, self-supervised training, reinforcement learning, and so on. In contrast to training/learning of the machine learning algorithm, the mapping system 270 implements the machine learning algorithm to perform inference. Thus, the general use of the machine learning algorithm is described as inference.

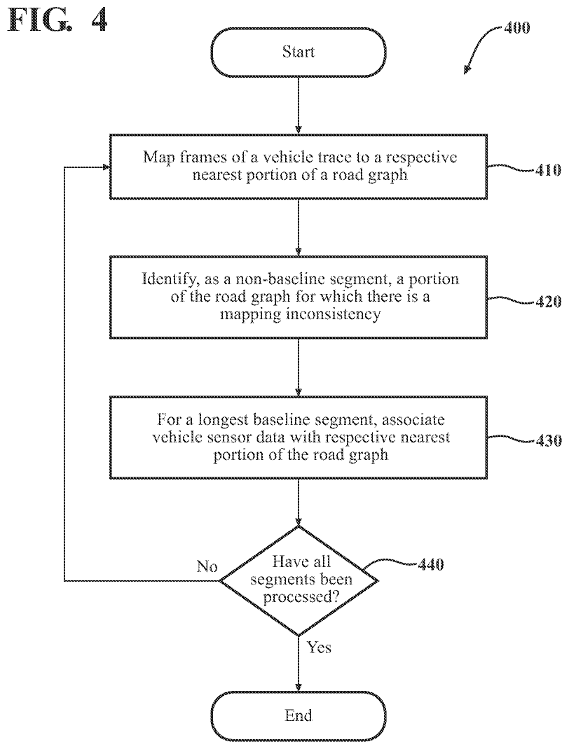

Additional aspects of associating vehicle sensor data with a road graph 255 will be discussed in relation to FIG. 4. FIG. 4 illustrates a flowchart of a method 400 that is associated with mapping vehicle traces to a road graph 255. Method 400 will be discussed from the perspective of the mapping system 270 of FIG. 2. While method 400 is discussed in combination with the mapping system 270, it should be appreciated that the method 400 is not limited to being implemented within the mapping system 270 but is instead one example of a system that may implement the method 400.

At 410, the map module 220 maps frames of a vehicle trace along a road to a respective nearest portion of a road graph 255 for the road. As such, the map module 220 receives, via the communication system 285 and the communication system 180 of a vehicle 100, the vehicle trace data, which includes multiple frames or points in time where vehicle location data is recorded and a time stamp associated with the location recordation. As described above, mapping of the frames of the vehicle trace to the road graph 255 may occur in various ways, including mapping frames to the nearest portion of the road graph 255 or the nearest node of the road graph 255.

At 420, the mapping inconsistency module 230 identifies, as a non-baseline segment, a portion of the road graph 255 for which there is no mapping inconsistency. A mapping inconsistency may take various forms, including an out-of-sequence mapping, a frame that maps to multiple road graphs, or other forms. In any case, the mapping inconsistency module 230 differentiates baseline segments from non-baseline segments. Baseline segments are associated with vehicle sensor data, while non-baseline segments are further processed as described below.

At 430, the association module 280, for a baseline segment, associates vehicle sensor data captured at the frames with the respective nearest portion of the road graph 255. That is, the vehicle 100 includes a sensor system 120. The output of the sensor system 120 is transmitted to the mapping system 270 such that the sensor data may augment the road graph 255. The augmented road graph 255 is then relied on by downstream systems for several reasons, including providing driver assistance, performing autonomous control of a vehicle, or recreating the environment of the road.

As such, the association module 280 controls the sensor system 120 to acquire the sensor data. In one embodiment, the association module 280 controls the radar sensor 123 and the camera 126 of the vehicle 100 to observe the surrounding environment. Alternatively, or additionally, the association module 280 controls the camera 126 and the LiDAR 124 or another set of sensors to acquire the sensor data. As part of controlling the sensors to acquire the sensor data, it is generally understood that the sensors acquire the sensor data of a region around the ego vehicle 100 with data acquired from different types of sensors generally overlapping in order to provide for a comprehensive sampling of the surrounding environment at each time step. In general, the sensor data need not be of the exact same bounded region in the surrounding environment but should include a sufficient area of overlap such that distinct aspects of the area can be correlated. Thus, the association module 280, in one embodiment, controls the sensors to acquire the sensor data of the surrounding environment. Moreover, in further embodiments, the association module 280 controls the sensors to acquire the sensor data at successive iterations or time steps. Additionally, as previously noted, the map module 220, when acquiring data from multiple sensors, fuses the data together to form the sensor data and to provide for improved determinations of detection, location, and so on.

In an example, the association module 280 associates the vehicle sensor data with a single baseline segment, specifically a longest baseline segment. In this example, once the vehicle sensor data is associated with the longest baseline segment of the road graph 255, the process repeats for the non-baseline segments with the longest consistent non-baseline segments being identified and associated with associated vehicle sensor data. As such, the method 400 is recursive such that the operations of 410-430 are performed for each non-baseline segment. That is, at 440, the mapping system 270 evaluates whether all segments of the road graph have been processed. If not, the method 400 iteratively executes operations 410-430 for each non-baseline segment. If all segments have been processed, the method 400 ends. As mapping inconsistencies are resolved at each step, the method 400 iteratively identifies segments for which there are no mapping inconsistencies and associates the vehicle sensor data for these segments to the road graph 255 such that the road graph 255 is populated with vehicle sensor data.

FIGS. 5A-5E illustrate the mapping of a road graph 255 to vehicle trace 505 data. Specifically, FIGS. 5A-5E depict a road graph 255 for a cloverleaf interchange where the road increases in elevation around the curve such that a vertical portion of the road passes over the horizontal portion of the road. As described above, the road graph 255 may have nodes indexed as R₁, R₂, . . . R₁₄. FIGS. 5A-5E also depict two vehicle traces 505-1 and 505-2, each recorded by a different vehicle traversing the road. As described above, each vehicle trace 505-1 and 505-2 may have frames. The first vehicle trace 505-1 frames are indexed as T₁, T₂, . . . T₃₀. For simplicity in illustration, just the frames of a first vehicle trace 505-1 are referenced with associated index numbers. As described above, the vehicle position is recorded at each frame. Moreover, as described above, vehicle sensor data is continuously or discretely collected by the vehicle 100 and associated with a respective frame.

FIG. 5B depicts the association of the vehicle trace 505-1 frames with the associated road graph 255 nodes. In the example depicted in FIG. 5B, the vehicle trace 505 frames are associated with the nearest road graph 255 node such that frame T₁₀ is associated with node R₄, and frame T₁₁ is associated with node R₅. In FIG. 5B, this association is indicated by the lines 515-1 and 515-2. Similar associations are made for each frame. As described above, given the overlapping nature of portions of the road graph 255, such a mapping may result in an inconsistency as frame T₆ may map to node R₁₂ (an overpassing section of road) instead of node R₂ (an underpassing section of road that the vehicle was traversing when data was collected at frame T₆). This inconsistency would result in vehicle sensor data captured at T₆ being incorrectly assigned to the road graph node R₁₂, which could introduce error in the operation of any system that relies on the road graph 255.

To remedy this inconsistency and, as depicted in FIG. 5C, the mapping inconsistency module 230 identifies a section of the road graph 255 for which there are no mapping inconsistencies. This baseline segment 525, which as described above may be a longest baseline segment for the road graph 255, is one for which the system can confidently associate vehicle sensor data with the road graph 255. Following the identification of the baseline segment 525, the association module 280 associates vehicle sensor data collected at times T₇-T₂₆ with the associated road graph nodes R₃-R₁₂.

As discussed above, the mapping system 270 recursively executes the method 400 such that the non-baseline segments 535-1, 535-2 depicted in FIGS. 5D and 5E are similarly processed. That is, the map module 220 associates vehicle trace 515 frames with respective portions of the road graph 255 found in each non-baseline segment 535-1, 535-2. However, a restriction is imposed on the processing of the non-baseline segments 535-1, 535-2. Specifically, road graph 255 nodes of the non-baseline segments 535-1, 535-2 are associated with frames of the vehicle trace 505-1 based on a timestamp of the frames and a timestamp of the frames associated with the baseline segment 525 such that as depicted in FIG. 5D, road graph nodes of the first non-baseline segment 535-1 that is geographically before the baseline segment 525 are associated with frames of the vehicle trace 505-1 that are temporally before the frames associated with the baseline segment 525. As such, frame T₆, which was previously mapped to node R₁₂ (see Table (1)), is no longer associated with node R₁₂ based on R₁₂ being geographically and temporally after R₁₂ and frame T₆ being temporally before T₇. This resolves the identified mapping inconsistency identified in Table (1) above.

Similarly, as depicted in FIG. 5E, road graph nodes of the second non-baseline segment 535-2 that are geographically after the baseline segment 525 are associated with frames of the vehicle trace 505-1 that are temporally after the frames associated with the baseline segment 525. As such, frame T₂₇, which was previously mapped to node R₂ (see Table (1)), is no longer associated with node R₂ based on R₂ being geographically and temporally before R₃ and frame T₂₇ being temporally after T₂₆. This resolves the identified mapping inconsistency identified in Table (1) above.

As such, the mapping system 270 of the present specification accurately augments a road graph 255 with vehicle sensor data by accounting for mapping inconsistencies between vehicle traces and road graphs 255.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 110. In one or more arrangements, the processor(s) 110 can be a primary/centralized processor of the vehicle 100 or may be representative of many distributed processing units. For instance, the processor(s) 110 can be an electronic control unit (ECU). Alternatively, or additionally, the processors include a central processing unit (CPU), a graphics processing unit (GPU), an ASIC, an microcontroller, a system on a chip (SoC), and/or other electronic processing units that support operation of the vehicle 100.

The vehicle 100 can include one or more data stores 115 for storing one or more types of data. The data store 115 can be comprised of volatile and/or non-volatile memory. Examples of memory that may form the data store 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 115 is a component of the processor(s) 110. In general, the data store 115 is operatively connected to the processor(s) 110 for use thereby. The term “operatively connected,” as used throughout this description, can include direct or indirect connections, including connections without direct physical contact.

In one or more arrangements, the one or more data stores 115 include various data elements to support functions of the vehicle 100, such as semi-autonomous and/or autonomous functions. Thus, the data store 115 may store map data 116 and/or sensor data 119. The map data 116 includes, in at least one approach, maps of one or more geographic areas. In some instances, the map data 116 can include information about roads (e.g., lane and/or road maps), traffic control devices, road markings, structures, features, and/or landmarks in the one or more geographic areas. The map data 116 may be characterized, in at least one approach, as a high-definition (HD) map that provides information for autonomous and/or semi-autonomous functions.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. In one or more arrangements, the map data 116 includes one or more static obstacle maps 118. The static obstacle map(s) 118 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 119 is data provided from one or more sensors of the sensor system 120. Thus, the sensor data 119 may include observations of a surrounding environment of the vehicle 100 and/or information about the vehicle 100 itself. In some instances, one or more data stores 115 located onboard the vehicle 100 store at least a portion of the map data 116 and/or the sensor data 119. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 120 and/or the one or more sensors can be operatively connected to the processor(s) 110, the data store(s) 115, and/or another element of the vehicle 100.

Various examples of different types of sensors will be described herein. However, it will be understood that the embodiments are not limited to the particular sensors described. In various configurations, the sensor system 120 includes one or more vehicle sensors 121 and/or one or more environment sensors. The vehicle sensor(s) 121 function to sense information about the vehicle 100 itself. In one or more arrangements, the vehicle sensor(s) 121 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 120 can include one or more environment sensors 122 that sense a surrounding environment (e.g., external) of the vehicle 100 and/or, in at least one arrangement, an environment of a passenger cabin of the vehicle 100. For example, the one or more environment sensors 122 sense objects the surrounding environment of the vehicle 100. Such obstacles may be stationary objects and/or dynamic objects. Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 includes one or more radar sensors 123, one or more LIDAR sensors 124, one or more sonar sensors 125 (e.g., ultrasonic sensors), and/or one or more cameras 126 (e.g., monocular, stereoscopic, RGB, infrared, etc.).

Continuing with the discussion of elements from FIG. 1, the vehicle 100 can include an input system 130. The input system 130 generally encompasses one or more devices that enable the acquisition of information by a machine from an outside source, such as an operator. The input system 130 can receive an input from a vehicle passenger (e.g., a driver/operator and/or a passenger). Additionally, in at least one configuration, the vehicle 100 includes an output system 135. The output system 135 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 140. Various examples of the one or more vehicle systems 140 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 141, a braking system 142, a steering system 143, a throttle system 144, a transmission system 145, a signaling system 146, and a navigation system 147.

The navigation system 147 can include one or more devices, applications, and/or combinations thereof to determine the geographic location of the vehicle 100 and/or to determine a travel route for the vehicle 100. The navigation system 147 can include one or more mapping applications to determine a travel route for the vehicle 100 according to, for example, the map data 116. The navigation system 147 may include or at least provide connection to a global positioning system, a local positioning system or a geolocation system.

In one or more configurations, the vehicle systems 140 function cooperatively with other components of the vehicle 100. For example, the processor(s) 110 and/or automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the navigation and/or maneuvering of the vehicle 100. The processor(s) 110, and/or the automated driving module(s) 160 may control some or all of these vehicle systems 140.

For example, when operating in the autonomous mode, the processor(s) 110 and/or the automated driving module(s) 160 control the heading and speed of the vehicle 100. The processor(s) 110, and/or the automated driving module(s) 160 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 150 in at least one configuration. The actuators 150 are, for example, elements operable to move and/or control a mechanism, such as one or more of the vehicle systems 140 or components thereof responsive to electronic signals or other inputs from the processor(s) 110 and/or the automated driving module(s) 160. The one or more actuators 150 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 110, implement one or more of the various functions described herein. In various arrangements, one or more of the modules are a component of the processor(s) 110, or one or more of the modules are executed on and/or distributed among other processing systems to which the processor(s) 110 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 160. The automated driving module(s) 160, in at least one approach, receive data from the sensor system 120 and/or other systems associated with the vehicle 100. In one or more arrangements, the automated driving module(s) 160 use such data to perceive a surrounding environment of the vehicle. The automated driving module(s) 160 determine a position of the vehicle 100 in the surrounding environment and map aspects of the surrounding environment. For example, the automated driving module(s) 160 determines the location of obstacles or other environmental features including traffic signs, trees, shrubs, neighboring vehicles, pedestrians, etc.

The automated driving module(s) 160 can be configured to determine travel path(s), current autonomous driving maneuvers for the vehicle 100, future autonomous driving maneuvers and/or modifications to current autonomous driving maneuvers based on data acquired by the sensor system 120 and/or another source. In general, the automated driving module(s) 160 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5E, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
map frames of a vehicle trace along a road to a respective nearest portion of a road graph for the road;
identify, as a non-baseline segment, a portion of the road graph for which there is a mapping inconsistency; and
for a baseline segment, associate vehicle sensor data captured at the frames with the respective nearest portion of the road graph.

2. The system of claim 1, wherein the machine-readable instructions further comprise a machine-readable instruction that, when executed by the processor, causes the processor to associate the non-baseline segment to the frames of the vehicle trace based on:
a timestamp of the frames; and
a timestamp of frames associated with the baseline segment.

3. The system of claim 2, wherein the machine-readable instructions further comprise a machine-readable instruction that, when executed by the processor, causes the processor to:
associate a first non-baseline segment that is geographically before the baseline segment with frames of the vehicle trace that are temporally before frames associated with the baseline segment; and
associate a second non-baseline segment that is geographically after the baseline segment with frames of the vehicle trace that are temporally after frames associated with the baseline segment.

4. The system of claim 3, wherein the machine-readable instructions further comprise a machine-readable instruction that, when executed by the processor causes the processor to, for non-baseline segments:
map frames of the vehicle trace along the non-baseline segment to a respective nearest portion of the non-baseline segment;
identify an inconsistent portion of the non-baseline segment; and
for a consistent portion of the non-baseline segment, associate vehicle sensor data captured at the frames along the non-baseline segment with the respective nearest portion of the non-baseline segment.

5. The system of claim 1, wherein the machine-readable instruction that, when executed by the processor, causes the processor to identify, as the non-baseline segment, the portion of the road graph for which there is the mapping inconsistency comprises a machine-readable instruction that, when executed by the processor, causes the processor to identify the mapping inconsistency based on a connection of nodes of the road graph.

6. The system of claim 1, wherein the machine-readable instruction that, when executed by the processor, causes the processor to identify, as the non-baseline segment, the portion of the road graph for which there is the mapping inconsistency comprises a machine-readable instruction that, when executed by the processor, causes the processor to identify an out-of-sequence mapping between a frame and a respective nearest portion of the road graph for the frame.

7. The system of claim 1, wherein the machine-readable instruction that, when executed by the processor, causes the processor to identify, as the non-baseline segment, the portion of the road graph for which there is the mapping inconsistency comprises a machine-readable instruction that, when executed by the processor, causes the processor to identify a frame that maps to multiple road graphs.

8. The system of claim 1, wherein the machine-readable instruction that, when executed by the processor, causes the processor to identify, as the non-baseline segment, the portion of the road graph for which there is the mapping inconsistency comprises a machine-readable instruction that, when executed by the processor, causes the processor to identify the mapping inconsistency based on at least one of:
a distance between a frame and a respective nearest portion of the road graph for the frame; or
a speed of a vehicle.

9. The system of claim 1, wherein the machine-readable instruction that, when executed by the processor, causes the processor to map frames of the vehicle trace along the road to the respective nearest portion of the road graph for the road comprises a machine-readable instruction that, when executed by the processor, causes the processor to map the frames to at least one of:
a respective nearest point along the road graph; or
a respective nearest node of the road graph.

10. The system of claim 1, wherein the machine-readable instruction that, when executed by the processor, causes the processor to associate vehicle sensor data captured at the frames with the respective nearest portion of the road graph comprises a machine-readable instruction that, when executed by the processor, causes the processor to associate at least one of elevation data for the vehicle or directionality data for a vehicle with the respective nearest portion of the road graph.

11. A non-transitory machine-readable medium comprising instructions that, when executed by a processor, cause the processor to:
map frames of a vehicle trace along a road to a respective nearest portion of a road graph for the road;
identify, as a non-baseline segment, a portion of the road graph for which there is a mapping inconsistency; and
for a baseline segment, associate vehicle sensor data captured at the frames with the respective nearest portion of the road graph.

12. The non-transitory machine-readable medium of claim 11, wherein the instructions further comprise an instruction that, when executed by the processor, causes the processor to associate the non-baseline segment to the frames of the vehicle trace based on:
a timestamp of the frames; and
a timestamp of frames associated with the baseline segment.

13. The non-transitory machine-readable medium of claim 12, wherein the instructions further comprise an instruction that, when executed by the processor, causes the processor to:
associate a first non-baseline segment that is geographically before the baseline segment with frames of the vehicle trace that are temporally before frames associated with the baseline segment; and
associate a second non-baseline segment that is geographically after the baseline segment with frames of the vehicle trace that are temporally after frames associated with the baseline segment.

14. The non-transitory machine-readable medium of claim 13, wherein the instructions further comprise an instruction that, when executed by the processor causes the processor to, for non-baseline segments:
map frames of the vehicle trace along the non-baseline segment to a respective nearest portion of the non-baseline segment;
identify an inconsistent portion of the non-baseline segment; and
for a consistent portion of the non-baseline segment, associate vehicle sensor data captured at the frames along the non-baseline segment with the respective nearest portion of the non-baseline segment.

15. The non-transitory machine-readable medium of claim 11, wherein the instruction that, when executed by the processor, causes the processor to identify, as the non-baseline segment, the portion of the road graph for which there is the mapping inconsistency comprises an instruction that, when executed by the processor, causes the processor to identify, as the mapping inconsistency, at least one of:
an out-of-sequence mapping between a frame and a respective nearest portion of the road graph for the frame;
or
a frame that maps to multiple road graphs.

16. A method, comprising:
mapping frames of a vehicle trace along a road to a respective nearest portion of a road graph for the road;
identifying, as a non-baseline segment, a portion of the road graph for which there is a mapping inconsistency; and
for a baseline segment, associating vehicle sensor data captured at the frames with the respective nearest portion of the road graph.

17. The method of claim 16, further comprising associating the non-baseline segment to frames of the vehicle trace based on:
a timestamp of the frames; and
a timestamp of frames associated with the baseline segment.

18. The method of claim 17, further comprising:
associating a first non-baseline segment that is geographically before the baseline segment with frames of the vehicle trace that are temporally before the frames associated with the baseline segment; and
associating a second non-baseline segment that is geographically after the baseline segment with frames of the vehicle trace that are temporally after the frames associated with the baseline segment.

19. The method of claim 18, further comprising for the non-baseline segment:
mapping frames of the vehicle trace along the non-baseline segment to a respective nearest portion of the non-baseline segment;
identifying an inconsistent portion of the non-baseline segment; and
for a consistent portion of the non-baseline segment, associating vehicle sensor data captured at the frames along the non-baseline segment with the respective nearest portion of the non-baseline segment.

20. The method of claim 16, wherein identifying, as the non-baseline segment, the portion of the road graph for which there is the mapping inconsistency comprises identifying an out-of-sequence mapping between a frame and a respective nearest portion of the road graph for the frame.
